(19) United States
(12) Patent Application Publication
(10) Pub. No.: US 2011/0203615 A1
(43) Pub. Date: Aug. 25, 2011

(54) METHOD AND APPARATUS FOR CLEANING PARTS IN DENSE PHASE CARBON DIOXIDE

(76) Inventors: Kenneth Stlg Lindqvist, Skarpnack (SE); Esko Ahlbom, Uppsala (SE)

(21) Appl. No.: 12/860,947

(22) Filed: Aug. 23, 2010

(30) Foreign Application Priority Data
Oct. 13, 2009 (EP) 09012929.7

(51) Int. Cl. B08B 5/00

(52) U.S. Cl. 134/21; 134/198

(57) ABSTRACT

The invention relates to a method for processing, in particular cleaning, objects in a cleaning fluid comprising dense phase carbon dioxide wherein said processing is carried out in a cleaning chamber and wherein at least a part of said dense phase carbon dioxide is withdrawn from said cleaning chamber and transferred back into said cleaning chamber, characterised in that gaseous carbon dioxide is withdrawn from said cleaning chamber, said gaseous carbon dioxide is compressed and said compressed carbon dioxide gas is injected into said cleaning chamber by means of an ejector wherein the passage of said carbon dioxide gas through said ejector causes a suction which sucks in said dense phase carbon dioxide withdrawn from said cleaning chamber.

The invention relates to a method and an apparatus for processing, in particular cleaning, objects in a cleaning fluid of dense phase carbon dioxide.

Dry cleaning using liquid carbon dioxide is known as an environmental friendly cleaning technique with favourable cleaning properties. Liquid carbon dioxide dry cleaning can be used to remove contaminants from garments or textiles as well as from metal, machinery, workpieces or other parts.

In a typical dry cleaning cycle the parts are cleaned in a cleaning chamber which has been filled with liquid carbon dioxide from a storage tank. When the cleaning is finished the liquid carbon dioxide is withdrawn from the cleaning chamber and passed to a still for distillation in order to remove contaminants from the liquid carbon dioxide. The distilled carbon dioxide is then returned to the storage tank for later use.

It is already known to circulate a part of the liquid carbon dioxide during the cleaning process. This is achieved by withdrawing liquid carbon dioxide from the cleaning chamber and pumping it back to the cleaning chamber. The liquid carbon dioxide circulation is achieved by means of piston pumps or centrifugal pumps. However, a piston pump has a low capacity and in operation it is rather noisy. Centrifugal pumps have problems to pump liquids without cavitation when the weight difference between the gaseous and the liquid phase is small. Thus, existing liquid carbon dioxide circulation systems require huge and costly pumps to be able to meet the requirements of capacity and pressure of liquid carbon dioxide.

Therefore, it is an object of the invention to provide an improved method and apparatus for circulating dense phase carbon dioxide.

This object is achieved by a method for processing, in particular cleaning, objects in a cleaning fluid comprising dense phase carbon dioxide wherein said cleaning is carried out in a cleaning chamber and wherein at least a part of said dense phase carbon dioxide is withdrawn from said cleaning chamber and transferred back into said cleaning chamber which is characterised in that gaseous carbon dioxide is withdrawn from said cleaning chamber, said gaseous carbon dioxide is compressed and said compressed carbon dioxide gas is injected into said cleaning chamber by means of an ejector wherein the passage of said carbon dioxide gas through said ejector causes a suction which sucks in dense phase carbon dioxide withdrawn from said cleaning chamber.

The inventive apparatus for processing parts in dense phase carbon dioxide comprising a cleaning chamber is characterized in that an ejector is provided for circulating dense phase carbon dioxide out of said cleaning chamber and back into said cleaning chamber, wherein said ejector has a gas inlet, a liquid inlet and an outlet, wherein said gas inlet is connected to an upper part of said cleaning chamber by means of a gas line and wherein a compressor is provided in the gas line, wherein said liquid inlet is connected to a lower part of said cleaning chamber and wherein said outlet is connected to said cleaning chamber.

According to the invention part of the dense phase carbon dioxide is circulated out of the cleaning chamber and back into the cleaning chamber. This circulation is achieved by making use of the jet pump principle, also known as Venturi effect. Gaseous carbon dioxide is withdrawn from the cleaning chamber and increased in pressure by means of a compressor. The compressed carbon dioxide gas is then passed through an ejector to inject the gas back into the cleaning chamber. When the carbon dioxide gas passes through the ejector it is accelerated whereby creating a suction according to the Venturi effect. The ejector comprises a liquid inlet connected to a liquid line containing the dense phase carbon dioxide withdrawn from the cleaning chamber. The suction created by the fast flowing gaseous carbon dioxide draws in dense phase carbon dioxide from the liquid line. Within the ejector the dense phase carbon dioxide is mixed with the accelerated carbon dioxide gas and injected into the cleaning chamber.

### BRIEF DESCRIPTION OF THE DRAWINGS

The method and apparatus according to the present invention will now be described by way of example with reference to the accompanying drawings, in which:

FIG. 1 schematically shows an inventive apparatus embodiment for CO2 dry cleaning,

FIG. 2 schematically shows an alternative embodiment of the invention,

FIG. 3 schematically shows the embodiment according to FIG. 2 with safety valves, and

FIG. 4 schematically shows another inventive embodiment.

### DETAILED DESCRIPTION OF THE INVENTION

The invention thus provides a circulation system for dense phase carbon dioxide which does not require huge and costly pumps such as a piston pump or a centrifugal pump.

The ejector preferably comprises a nozzle assembly with a jet nozzle, a receiving nozzle and a diffuser as well as a liquid line inlet, whereby a gaseous flow exiting the jet nozzle and having a high flow velocity draws in the liquid from the liquid line inlet. The liquid or dense phase carbon dioxide is drawn in by the gas. Both liquid and gas, i.e. gaseous flow, are then mixed during their way through the receiving nozzle, usually in a narrowing part of the so called receiving nozzle. Downstream of the receiving nozzle is a diffuser, in general a widening part of a nozzle, wherein the flow is pressurised before exiting the diffuser and being introduced into the cleaning chamber as described above.

The term “ejector” shall cover embodiments where the fluid which is sucked in is ejected against atmospheric pressure as well as being ejected against a higher than atmospheric pressure.

The term “processing objects” shall include methods for changing the surface or the properties of an object, for example fatting, defatting, colouration, impregnation. “Processing” shall especially mean cleaning objects in a cleaning fluid comprising dense phase carbon dioxide.

Since cleaning is the preferred way of processing the objects the terms “cleaning fluid” and “cleaning chamber” will be used throughout this application. However, both terms “cleaning fluid” and “cleaning chamber” shall be understood in a broad manner, namely to include any kind of fluid or chamber, respectively, which are used for the intended processing.

The term “object” shall in particular mean garments, textiles, leather, leather products, animal hides, blankets, pillows, mattresses, metal, glass and plastic parts.

The term “dense phase carbon dioxide” shall mean super-critical carbon dioxide or, preferably, liquid carbon dioxide.

In the following the withdrawal of dense phase carbon dioxide from the cleaning chamber and the subsequent re-introduction into the cleaning chamber is also called circulation of dense phase carbon dioxide.

In a preferred embodiment said gaseous carbon dioxide is compressed by means of a compressor and the flow of the dense phase carbon dioxide being transferred back into the cleaning chamber is controlled by controlling the speed of said compressor and/or by using a control valve for the gaseous flow through the ejector. That means by regulating the flow of gaseous carbon dioxide through the ejector the suction force can be regulated. Thus, the flow of dense phase carbon dioxide which is sucked in can be controlled.

It is often desirable to remove or selectively absorb solvents, co-solvents, surfactants, particulate materials and the like during the cleaning cycle and in particular to continuously filter the cleaning fluid during a cleaning cycle, in order to assure the maximum degree of removal of particles. Thus, according to a preferred embodiment the dense phase carbon dioxide withdrawn from the cleaning chamber passes a filter or an absorbent material before entering the ejector. Dirt, loose fibers, particles, water and the like are retained mechanically or by way of absorption. The inventive circulation by gas injection allows to continuously filter the cleaning fluid.

In one embodiment, simple net filters (e.g. made of steel wire) are arranged in the liquid line, for example in order to collect loose fibers during a garment cleaning cycle.

The filters are ideally constructed in such a manner that they can be easily changed or replaced. Filters for removal of fibers and water can be combined by using a non-woven structure of e.g. polypropylene fibers which holds super-absorbent materials such as acrylates or highly hygroscopic materials.

In dry cleaning systems, water is useful as additive in order to assist the removal of hydrophilic stains. Also, certain useful surfactants exhibit higher solubility in the presence of water than in pure CO₂ (carbon dioxide). Therefore, water is added in the practice of dry cleaning with carbon dioxide because of its beneficial aspects, e.g. in the form of aqueous-based prespotters, or surfactants dissolved in water which are introduced directly into the cleaning chamber. The water can then be removed from the cleaning fluid by filtration or absorption.

It is further preferred to redirect the flow of cleaning fluid during draining of the cleaning chamber backwards through said filter and into the still. In this way any dirt and particulates which have been collected in the filter are washed out by the drained cleaning fluid and transferred into the still. This method represents an easy way of cleaning the filter by only redirecting the drained fluid.

The ejector can also be used to introduce an additive into the cleaning chamber. The term “additive” shall for example include chemicals, surfactants, perfumes.

Additional chemicals or other additives used in the cleaning process can be introduced into the cleaning chamber via the ejector to achieve a desired concentration and an improved even distribution of the additive over the parts to be processed. The introduction of additives can be done at any time during the process cycle.

For example, the additives can be introduced into the cleaning chamber in a controlled manner by taking the chemicals from a high pressure container. The high pressure container could be pressurised by the compressor which is used to enhance the pressure of the gaseous carbon dioxide withdrawn from the cleaning chamber. The carbon dioxide gas is taken from the cleaning chamber, and passed to the high pressure container where it mixes with the additives and pressurizes the high pressure container.

Alternatively, it is also possible to suck in the additives from an additive tank by using the ejector. The additives could be sucked in and then injected into the cleaning chamber together with the dense phase carbon dioxide or separately.

Both methods allow a significant amount of additional chemicals being introduced into the cleaning chamber with excellent possibilities of controlling the introduced amount.

Further, more than one additional high pressure container can be used, for example to enable re-use of the additives and/or to inject different additives at certain process stages into the cleaning chamber.

The invention allows for example to introduce colour and pigments into the cleaning chamber. It may also be used to introduce solid or sparingly soluble medical substances or pharmaceuticals in a similar manner into condensed gas, and/or to impregnate said substances or to distribute them on suitable surfaces.

Another example of additives which can be added into the cleaning chamber are special surfactants of non-ionic, cationic or anionic type which are meant to improve the “grip” or the “feel” of textiles, or perfumes which are equally meant to be absorbed by the garment surfaces.

In addition to or instead of a filter, a chemical treatment unit can be used to separate contamination, especially fatty contamination, from the dense phase carbon dioxide withdrawn from the cleaning chamber.

Such a chemical treatment unit can comprise a condenser separating the contamination from the dense phase carbon dioxide by being chilled to a predetermined temperature. To clean the chemical treatment unit it is possible to reverse the flow direction during draining of the cleaning chamber, which is especially useful when the chemical treatment unit is provided in addition to a filter. During draining additional cleaning chemicals being useful to clean the chemical treatment unit and/or the filter can be added. It is possible to introduce such cleaning chemicals via the high pressure container.

The inventive addition of chemicals and additives is in particular useful in the treatment of leather with dense phase carbon dioxide, for example when leather or animal hides are fatliquoured, fatted or defatted.

The draining of the cleaning chamber is preferably done by pressurising the cleaning chamber by means of a compressor taking gas from the still and pressing it into the cleaning chamber whereby the drain valve of the cleaning chamber is open.

The circulating dense phase carbon dioxide which has been withdrawn from the cleaning chamber is preferably re-introduced into the cleaning chamber by means of an ejector located in the door of the cleaning chamber. The ejector can also be located at the place of the intake into the cleaning chamber of liquid carbon dioxide derived from the storage tank. The ejector can also be built in the axis of the cleaning drum, which is the rotating part of the cleaning chamber or elsewhere mounted at the cleaning chamber, preferably being located at a point from which it is possible to create a carbon dioxide shower showering the parts to be processed in the cleaning chamber, e.g. showering garments to be cleaned.

It is further preferred to direct the flow of circulating dense phase carbon dioxide via a heat exchanger to the ejector. The dense phase carbon dioxide is withdrawn from the cleaning chamber and passed through a heat exchanger before being sucked into the ejector and re-introduced into the cleaning chamber. The heat exchanger is preferably located upstream of the liquid line inlet to the ejector. Thereby it is possible to control the temperature of the circulating dense phase carbon dioxide and hence to control the temperature in the cleaning chamber.

In dry cleaning systems, water is useful as an additive in order to assist the removal of hydrophilic stains. Water and mixtures of water and water soluble surfactants can form aggregates in carbon dioxide at temperatures below 5° C. to 9° C. Thus, the temperature of the circulating dense phase carbon dioxide is preferably controlled and can be set to a desired level. In that way, a constant cleaning efficiency is achieved.

It is preferred to continuously circulate dense phase carbon dioxide by using the invention. It is also possible to have alternately a cleaning phase without circulation of dense phase carbon dioxide and a cleaning phase with circulation of dense phase carbon dioxide. In the latter case it is preferred to have each phase between 2 and 12 times, more preferably between 3 and 10 times.

The invention has several advantages compared to the state of the art technology:
simple system for circulating dense phase carbon dioxide, especially liquid carbon dioxide, without using any pump, especially without a piston pump or a centrifugal pump
circulation can be used to filter out particles or water
introduction of additives into the cleaning chamber by means of the ejector
normal compressor can be used to compress the gaseous carbon dioxide withdrawn from the cleaning chamber

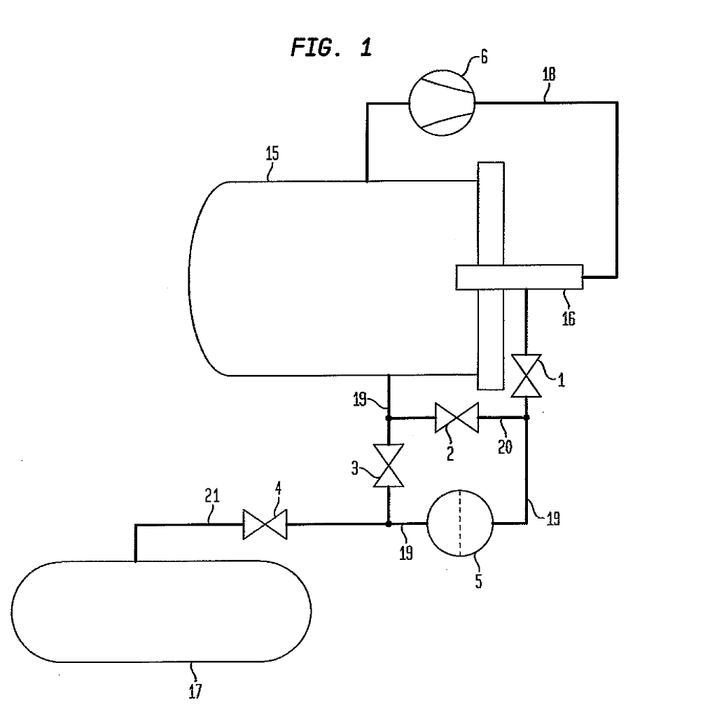

FIG. 1 schematically shows a carbon dioxide dry cleaning apparatus according to the invention. The apparatus may be used for cleaning garments, textiles, leather and similar goods, or for cleaning or processing of industrial parts in liquid carbon dioxide.

A cleaning chamber 15 is loaded with garments to be cleaned, filled with liquid carbon dioxide and pressurized with gaseous carbon dioxide. A gas compressor 6 located in gaseous line 18 takes gaseous carbon dioxide from the top of the cleaning chamber 15, pressurizes the gaseous CO₂ and passes it to an ejector 16. Within the ejector 16 the compressed CO₂ gas is forced through a nozzle and thereby accelerated creating a high speed CO₂ gas jet.

A liquid line 19 connects the bottom of the cleaning chamber with the ejector 16. Liquid line 19 is provided with a valve 3, a filter 5 and a valve 1. Filter 5 can be bypassed by bypass 20 with valve 2. Liquid line 19 is also connected via line 21 with valve 4 to still 17.

Liquid carbon dioxide is taken from the bottom of the cleaning chamber 15 and is passed through valve 3, filter 5, valve 1 to the ejector 16. In the ejector 16 the high speed CO₂ gas creates a suction such that liquid CO₂ from liquid line 19 is sucked in, mixed with the high speed CO₂ gas and injected into the cleaning chamber 15. In this way a circulation for liquid carbon dioxide is created.

The flow of liquid CO₂ through the ejector 16 can be controlled by controlling the speed of compressor 6. To control the liquid CO₂ flow it is also possible (not shown in the drawing) to provide a control valve in the gas line 18 upstream of the ejector 16 and an overflow valve bypassing the ejector 16.

During draining of the cleaning chamber 15 valves 3, 1 are closed and valve 2 is opened. The drain flow is thus directed backwards through filter 5 in order to clean filter 5 and to wash any particulates which have been accumulated in the filter 5 into the distiller 17.

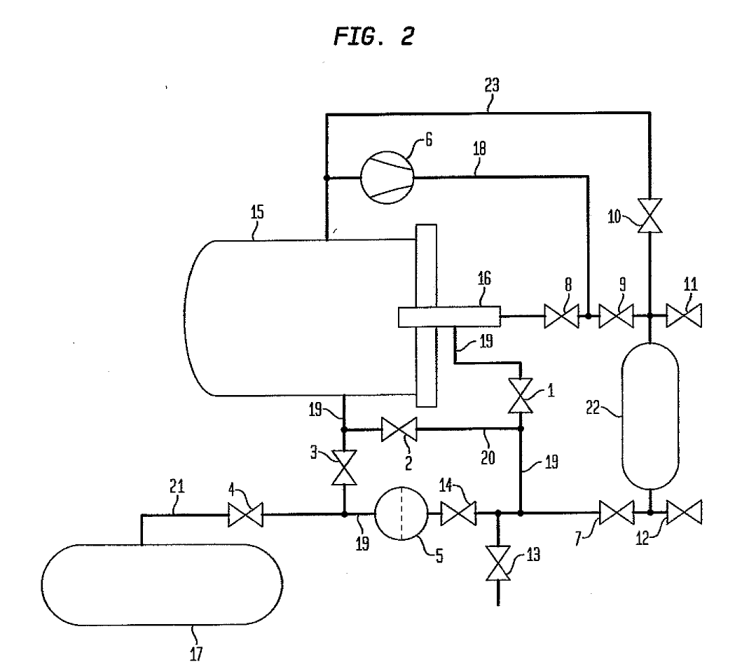

FIG. 2 shows another embodiment of the invention which allows to inject additives, such as chemicals, into the cleaning chamber 15. Such additives can be injected via valve 13 into liquid line 19. The additives are mixed with the liquid carbon dioxide and then injected into the cleaning chamber 15 by means of ejector 16. The injection of additives into liquid line 19 can be done any time during the cleaning cycle. The inventive introduction of the additives allows a controlled concentration and better distribution of the additives into the cleaning chamber 15.

A controlled intake of additives can also be achieved from a high pressure additive tank or high pressure container 22. The high pressure additive tank 22 can be pressurized by the compressor 6 taking gas from the cleaning chamber 15 and passing it through gas line 18 and valve 9 into tank 22. The increased pressure in tank 22 pushes additives from tank 22 via valve 7, line 19 and valve 1 to the ejector 16.

It is also possible to use the suction effect of ejector 16 to take additives from tank 22 into the cleaning chamber 15. In that case valve 10 in line 23 is opened to achieve a pressure equalisation of tank 22 with the cleaning chamber 15. Opening valves 7, 1 sucks in additives from tank 22 to the low-pressure side of the ejector 16 which are then sprayed into the cleaning chamber 15.

All methods described above allow a significant amount of chemicals or additives injected into the cleaning chamber 15 with an excellent control of the amount. The amount can easily be controlled by inserting the chemicals in a low-pressure state into the high pressure tank 22 using valves 11 and/or 12. When a larger amount of additives is added valve 10 is preferably opened to keep the pressure stable. The amount of chemicals in tank 22 could be measured in several ways by standard equipment on the market.

The inventive injector system can also be used for processes where liquid chemicals, other than liquid CO₂, are used and there is a need to circulate these chemicals through filter, heater, chiller, chemical treatment unit, etc. This process can be done as long as there is some gas in the system that can drive the injector, for example, water and ozone. An ozone generator could be placed between gas compressor 6 and valve 8.

It is further possible to have several high pressure tanks 22 in the system, for example when chemicals shall be re-used, or different chemicals are used in different process steps, etc. Instead of the high-pressure tanks 22 it is also possible to connect external distiller(s) of desired type and application.

Instead of, or in combination with filter unit 5 it is possible to place a chemical treatment unit, for example a condenser for grease/fat, that will condensate and separate chemicals from the liquid CO₂ when chilled to a certain temperature. Back-flowing the chemical treatment unit during draining can clean the chemical treatment unit in the same way as the filter 5 can be cleaned. If additional chemicals are needed to clean the filter 5 or the chemical treatment unit it is possible to inject these chemicals through valve 13 during draining. It is also possible to use the high-pressure tank 22 to press chemicals through the filter 5 and/or chemical treatment unit. All draining of the cleaning chamber 15 is preferably done by pressurizing cleaning chamber 15 with gas compressor 6 taking gas from distiller 17 and pressing it into the cleaning chamber 15 and having the drain valve/valves open. This is done by opening the way for the gas to flow through the high-pressure tank 22 and through the filter 5 and/or chemical treatment unit and then to the distiller. Valves 10, 7, 14 and 4 are open.

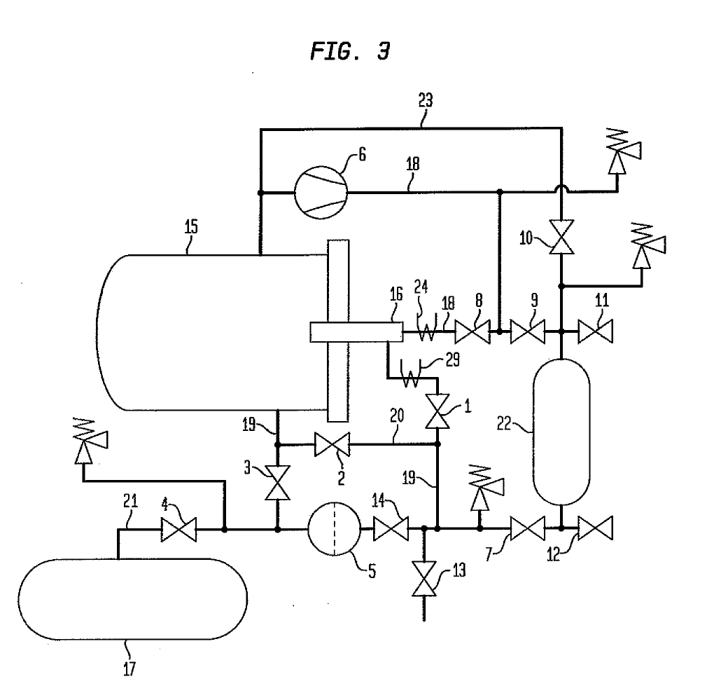

In the embodiment shown in FIG. 3 a heat exchanger 24, 29 is added upstream of the ejector 16 on the liquid side in line 19, on the gas side in line 18 or in both lines 18, 19. Heat exchangers 24, 29 allow to control the temperature of the cleaning chamber 15.

FIG. 3 further shows safety valves. It is further preferred to place expansion bottles in parallel to the safety valves.

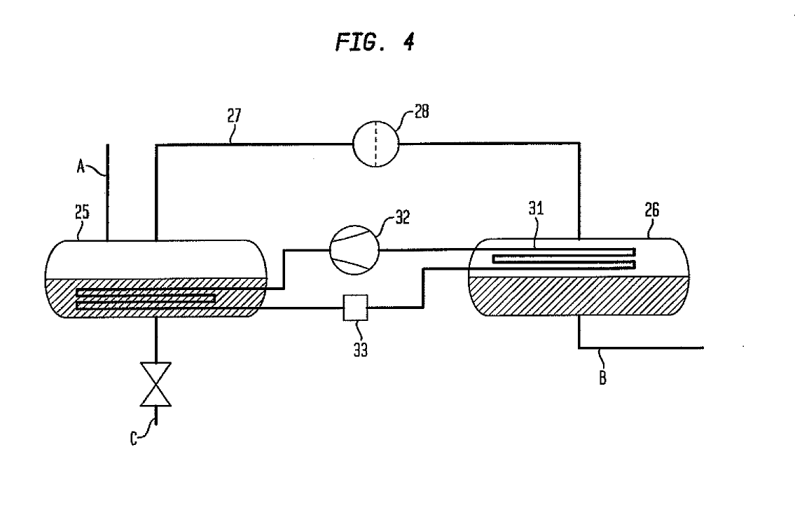

An inline distillation unit as shown in FIG. 4 can be used as a chemical treatment unit. The inline distillation unit is provided instead of or in addition to filter 5. The inline distillation unit comprises a distiller tank 25 and a condenser tank 26 which are connected by a gas line 27 which can be provided with a filter, purifier or absorber 28.

A heating/chilling unit comprising two heat exchangers 30, 31, a pump or compressor 32 and an expansion valve 33 exchanges heat between the distiller tank 25 and the condenser tank 26. Liquid CO₂ enters the distiller unit 25 through pipe A. In the distiller unit 25 the liquid CO₂ is vaporized with by means of heat exchanger 30 on the hot side of the heating/chilling unit. The vaporized CO₂ is transported through line 27 and filter 28 into the condenser tank 26. In condenser tank 26 the CO₂ gas is condensed to liquid CO₂ by means of heat exchanger 31 on the cold side of the heating/chilling unit. Pure liquid CO₂ can then be pumped out from condenser tank 26 into line B. Waste from distiller tank 25 can be purged out through pipe C.

1. Method for processing, in particular cleaning, objects in a cleaning fluid comprising dense phase carbon dioxide wherein said processing is carried out in a cleaning chamber and wherein at least a part of said dense phase carbon dioxide is withdrawn from said cleaning chamber and transferred back into said cleaning chamber, characterised in that gaseous carbon dioxide is withdrawn from said cleaning chamber, said gaseous carbon dioxide is compressed and said compressed carbon dioxide gas is injected into said cleaning chamber by means of an ejector wherein the passage of said carbon dioxide gas through said ejector causes a suction which sucks in said dense phase carbon dioxide withdrawn from said cleaning chamber.

2. Method according to claim 1 characterised in that said gaseous carbon dioxide is compressed by means of a compressor and that the flow of the dense phase carbon dioxide being transferred back into the cleaning chamber is controlled by controlling the speed of said compressor and/or by using a control valve for the flow of said gaseous carbon dioxide through the ejector.

3. Method according to claim 1 characterised in that said dense phase carbon dioxide withdrawn from said cleaning chamber passes through a filter before entering the ejector.

4. Method according to claim 3 characterised in that said cleaning chamber is drained into a still and that said drained cleaning fluid is redirected backwards through said filter and into said still.

5. Method according to claim 1 characterised in that an additive is introduced into said cleaning chamber via the ejector.

6. Method according to claim 3 characterised in that a chemical treatment unit is used in addition to or instead of said filter to separate contamination, especially fatty contamination, from said dense phase carbon dioxide withdrawn from said cleaning chamber.

7. Method according to claim 1 characterised in that said flow of dense phase carbon dioxide withdrawn from said cleaning chamber is directed via a heat exchanger to said ejector.

8. Apparatus for processing parts in dense phase carbon dioxide comprising a cleaning chamber, characterised in that an ejector is provided for circulating dense phase carbon dioxide out of said cleaning chamber and back into said cleaning chamber, wherein said ejector has a gas inlet, a liquid inlet and an outlet, wherein said gas inlet is connected to an upper part of said cleaning chamber by means of a gas line and wherein a compressor is provided in the gas line, wherein said liquid inlet is connected to a lower part of said cleaning chamber by means of a liquid line and wherein said outlet of said ejector is connected to said cleaning chamber.

9. Apparatus according to claim 8 characterized in that a filter and/or an absorber is provided in said liquid line.

10. Apparatus according to claim 8 characterized in that a supply device for additives is connected to said ejector.
